(19) United States
(12) Patent Application Publication
(10) Pub. No.: US 2014/0292776 A1
(43) Pub. Date: Oct. 2, 2014

(54) ELECTRONIC APPARATUS AND CONTROL METHOD

(71) Applicant: Kabushiki Kaisha Toshiba, Tokyo (JP)

(72) Inventor: Kei Tanaka, Ome-shi (JP)

(73) Assignee: Kabushiki Kaisha Toshiba, Tokyo (JP)

(21) Appl. No.: 14/070,267

(22) Filed: Nov. 1, 2013

Related U.S. Application Data
(63) Continuation of application No. PCT/JP2013/058803, filed on Mar. 26, 2013.

(51) Int. Cl. G09G 5/00

(52) U.S. Cl. CPC G09G 5/006
USPC 345/520

(57) ABSTRACT

According to one embodiment, an electronic apparatus includes a sensor module, a second acceleration sensor and a controller. The sensor module includes a plurality types of sensors including a first acceleration sensor. The controller determines, before booting an installed operating system, whether the installed operating system is a first operating system or a second operating system. If the installed operating system is determined to be the first operating system, the controller boots the installed operating system after turning the sensor module on. If the installed operating system is determined to be the second operating system, the controller boots the installed operating system without turning the sensor module on.

### CROSS-REFERENCE TO RELATED APPLICATIONS

This application is a Continuation Application of PCT Application No. PCT/JP2013/058803, filed Mar. 26, 2013, the entire contents of which are incorporated herein by reference.

### FIELD

Embodiments described herein relate generally to an electronic apparatus, and a control method applied to the electronic apparatus.

### BACKGROUND

Recently, various types of electronic devices such as a tablet computer and a notebook type of personal computer (PC) have been developed. Many of these electronic devices comprise an acceleration sensor.

Such an electronic device is capable of using the acceleration detected by the acceleration sensor to control various operations of the electronic device.

In recent years, a sensor module comprising various types of sensors including an acceleration sensor is beginning to be mounted on electronic devices.

As described above, the sensor module comprises a plurality of sensors, and thus consumes a comparatively large amount of electrical power. Therefore, if this sensor module is activated at any time regardless of the use environment of an electronic device, the electronic device may unnecessarily consume electricity.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view illustrating an overview of the electronic apparatus according to the embodiments.

FIG. 2 is a block diagram illustrating an example of a system configuration of the electronic apparatus according to the embodiments.

FIG. 3 is a block diagram illustrating relationships among a plurality of components provided within the electronic apparatus according to the embodiments.

FIG. 4 is a block diagram illustrating relationships of each of a sensor fusion and an acceleration sensor with other components, within the electronic apparatus according to the embodiments.

FIG. 5 is a view illustrating components to which power is supplied when the first operating system is booted in the block diagram shown in FIG. 4.

FIG. 6 is a view illustrating components to which power is supplied when the second operating system is booted in the block diagram shown in FIG. 4.

FIG. 7 is a flowchart illustrating procedures of a control process executed by the electronic apparatus according to the embodiments.

FIG. 8 is a view for explaining a parameter relating to the acceleration sensor provided in the electronic apparatus according to the embodiments.

FIG. 9 is a view for explaining a screen rotation process executed by the electronic apparatus according to the embodiments.

### DETAILED DESCRIPTION

Various embodiments will be described hereinafter with reference to the accompanying drawings.

In general, according to one embodiment, an electronic apparatus comprises a sensor module, a second acceleration sensor and a controller. The sensor module comprises various types of sensors including a first acceleration sensor. The controller determines, prior to booting an operating system installed on the electronic apparatus, whether the installed operating system is a first operating system allowed to execute control in accordance with detected values of the various types of sensors or a second operating system allowed to execute control in accordance with acceleration information. If the installed operating system is determined to be the first operating system, the controller boots the installed operating system after turning the sensor module on. If the installed operating system is determined to be the second operating system, the controller boots the installed operating system without turning the sensor module on.

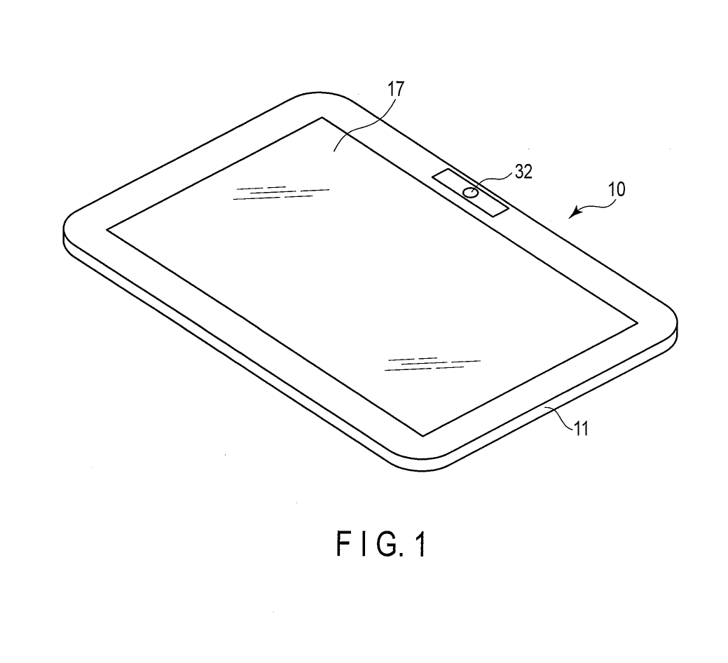

The overview of the electronic apparatus according to the embodiments will be described with reference to FIG. 1.

An electronic apparatus 10 is a tablet computer or a notebook type of personal computer (PC), etc. This specification hereinafter explains the electronic apparatus 10, assuming that the electronic apparatus 10 is a tablet computer.

The computer 10 is composed of a computer main body 11 and a touchscreen display 17. The computer main body 11 comprises a housing having a thin box shape. The touchscreen display 17 is located on a surface of the computer main body 11. The touchscreen display 17 comprises a flat panel display (for example, a liquid crystal display device (LCD)) and a touchpanel. The touchpanel is provided so as to cover a screen of the LCD. The touchpanel is configured to detect the location touched by a user with a finger or a pen on the touchscreen display 17. As shown in FIG. 1, the computer main body 11 may comprise a webcam 32, etc.

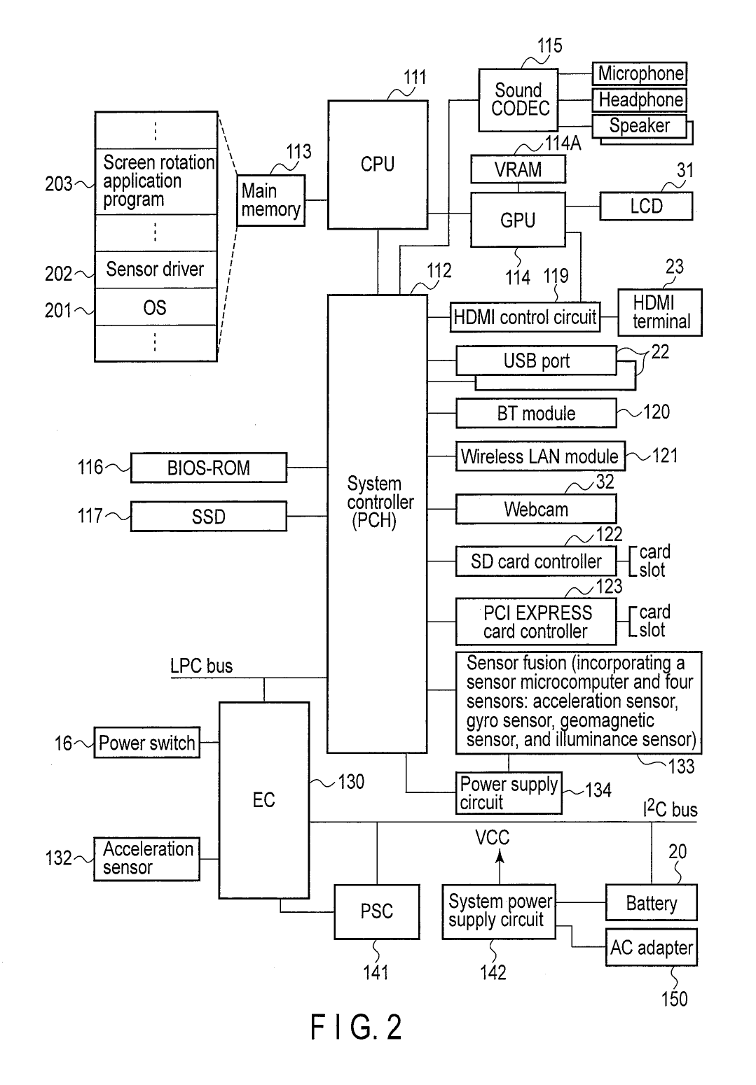

Next, a system configuration example of the computer 10 is explained with reference to FIG. 2.

The computer 10 has a hardware configuration which is capable of supporting a plurality of different operating systems (OS) in the same hardware system configuration indicated in FIG. 2. Even if one of different OSs is installed on the computer 10 and is booted, the computer 10 is capable of executing a screen rotation function, etc. described later.

FIG. 2 illustrates the system configuration of the computer 10. The computer 10 comprises a USB port 22, a CPU 111, a system controller (platform controller hub (PCH)) 112, a main memory 113, a graphics processing unit (GPU) 114, a sound codec 115, a BIOS-ROM 116, a solid-state drive (SSD) 117, a BT (Bluetooth™) module 120, a wireless LAN module 121, an SD card controller 122, a PCI EXPRESS card controller 123, an embedded controller (EC) 130, an acceleration sensor 132, a sensor fusion 133, a power supply circuit 134, a power supply controller (PSC) 141 and a system power supply circuit 142, etc.

The CPU 111 is a processor which controls operation of each component of the computer 10. The CPU 111 executes various types of software loaded from the SSD 117 to the main memory 113. In the software, an OS 201, a sensor driver 202 and various types of application programs are included. Further, the application programs include a screen rotation application program 203.

The sensor fusion 133 is a sensor module comprising plurality types of sensors including an acceleration sensor. The plurality types of sensors include an acceleration sensor, a gyro sensor, a geomagnetic sensor and an illuminance sensor, etc. The sensor fusion 133 further comprises a sensor microcomputer which controls these plural types of sensors.

As stated above, the computer 10 supports a plurality of different OSs. The embodiments are hereinafter explained, presuming a case in which one of two different types of OSs is installed on the computer 10 and the installed OS is loaded as the aforementioned OS 201 from the SSD 117 to the main memory 113. The two types of OSs are hereinafter referred to as a first OS and a second OS. As the first OS, for example, Windows™ 8 is assumed. As the second OS, for example, Windows™ 7 is supposed.

The first OS supports the sensor fusion 133 (sensor module). The first OS can execute control in accordance with the detected values of the plurality types of sensors included in the sensor fusion 133. The first OS comprises the sensor driver 202 which controls the sensor fusion 133. The first OS uses the sensor driver 202 to obtain the detected value of each sensor from the sensor fusion 133.

In the case where the first OS is installed on the computer 10, the first OS is loaded from the SSD 117 to the main memory 113. At this time, the sensor driver 202 is also loaded to the main memory 113. The first OS has a screen rotation function.

This screen rotation function is a function of automatically controlling the orientation of a screen image displayed on the screen of the computer 10 depending on the orientation of the computer 10. The orientation of the computer 10 is determined based on the acceleration information obtained by the acceleration sensor. For example, the screen rotation function is used to control the orientation for displaying a screen image. This orientation is controlled by obtaining detected values (acceleration information) of the acceleration sensor, and determining the orientation of the computer 10, for example, a longitudinal orientation or a lateral orientation, based on the obtained values.

The first OS uses the acceleration detected by the acceleration sensor (first acceleration sensor) included in the sensor fusion 133 to automatically execute the screen rotation function. Even if the screen rotation function is executable only with the detection result of the acceleration sensor, the first OS uses the acceleration information output from the sensor fusion 133 instead of the acceleration sensor 132 to execute the screen rotation function. In short, based on the output information from the sensor fusion 133 including the illuminance sensor etc., the first OS executes the screen rotation function which can perform control without using the detection result by sensors such as the illuminance sensor.

The second OS does not support the sensor fusion 133. However, the second OS can execute control in accordance with the acceleration information corresponding to the acceleration detected by the acceleration sensor 132 (second acceleration sensor) in conjunction with a Basic Input/Output System (BIOS) and the screen rotation application program 203. Specifically, the second OS executes the screen rotation function explained above, using the acceleration detected by the acceleration sensor 132 in conjunction with the BIOS and the screen rotation application program 203. However, the second OS is not able to directly access the acceleration sensor 132. Therefore, the second OS obtains acceleration information from the acceleration sensor 132 via the BIOS or the screen rotation application program 203 associated with the second OS. Further, the BIOS or the screen rotation application program 203 instructs the second OS to change the orientation for displaying a screen based on the obtained acceleration information. By such a process, etc., the computer 10 executes the screen rotation function in the second OS.

The screen rotation application program 203 is a program for executing the aforementioned screen rotation function. The screen rotation application program 203 executes the screen rotation function in cooperation with the second OS.

In the case where the second OS is installed on the computer 10, the second OS is loaded from the SSD 117 to the main memory 113. In this case, the screen rotation application program 203 is loaded to the main memory 113 without loading the sensor driver 202 to the main memory 113.

The second OS can also control the sensor fusion 133 by using a sensor driver dedicated to the second OS for controlling the sensor fusion 133.

The acceleration sensor 132 is utilized by the second OS. The acceleration sensor 132 is connected to the EC 130. The connection of the acceleration sensor 132 to the EC 130 eliminates the need for addition of an IC dedicated to conducting interface with the acceleration sensor 132. Thus, the acceleration sensor 132 can be controlled while electrical power is saved.

The power supply circuit 134 is a circuit which executes control for separately turning the sensor fusion 133 on or off. The power supply circuit 134 turns the sensor fusion 133 on or off based on control signals input from an external (the PCH 112).

The BIOS-ROM 116 is a nonvolatile memory which stores the BIOS. The BIOS is a system program for hardware control executed by the CPU 111. The BIOS includes a routine for executing a power-on self-test (POST) and a routine for booting the OS 201.

The GPU 114 is a display controller which controls the LCD 17 used as a display monitor of the computer 10. The GPU 114 generates a display signal to be supplied to the LCD 17 from the display data stored in a video memory (VRAM) 114A. An HDMI output terminal 23 can transmit an HDMI video signal (uncompressed digital video signal) and a digital audio signal to an external display by one cable. An HDMI control circuit 119 is an interface for sending an HDMI video signal and a digital audio signal to an external display via the HDMI output terminal 23.

The system controller (PCH) 112 is a bridge device connecting the CPU 111 to each component. The PCH 112 houses an Integrated Drive Electronics (IDE) controller for controlling the SSD 117. Further, the system controller 112 communicates with each device on a Low Pin Count (LPC) bus.

The EC 130 is a power management controller for managing power of the computer 10. The EC 130 has a function of turning the computer 10 on or off in accordance with a user operation of a power switch 16 of the computer 10.

The EC 130 is connected to the LPC bus. The EC 130, the PSC 141 and a battery 20 are connected to each other via a serial bus such as an I²C bus.

Power-on and power-off of the computer 10 is controlled by the EC 130 in conjunction with the PSC 141. When an ON signal transmitted from the EC 130 is received, the PSC 141 controls the system power supply circuit 142 so as to turn the computer 10 on. When an OFF signal transmitted from the EC 130 is received, the PSC 141 controls the system power supply circuit 142 so as to turn the computer 10 off. The EC 130, the PSC 141 and the system power supply circuit 142 are operated with power from the battery 20 or an AC adapter 150 even while the computer 10 is turned off.

The system power supply circuit 142 generates electrical power (operating power) to be supplied to each component by using power from the battery 20 or power from the AC adapter 150 connected as external power to the computer main body 11.

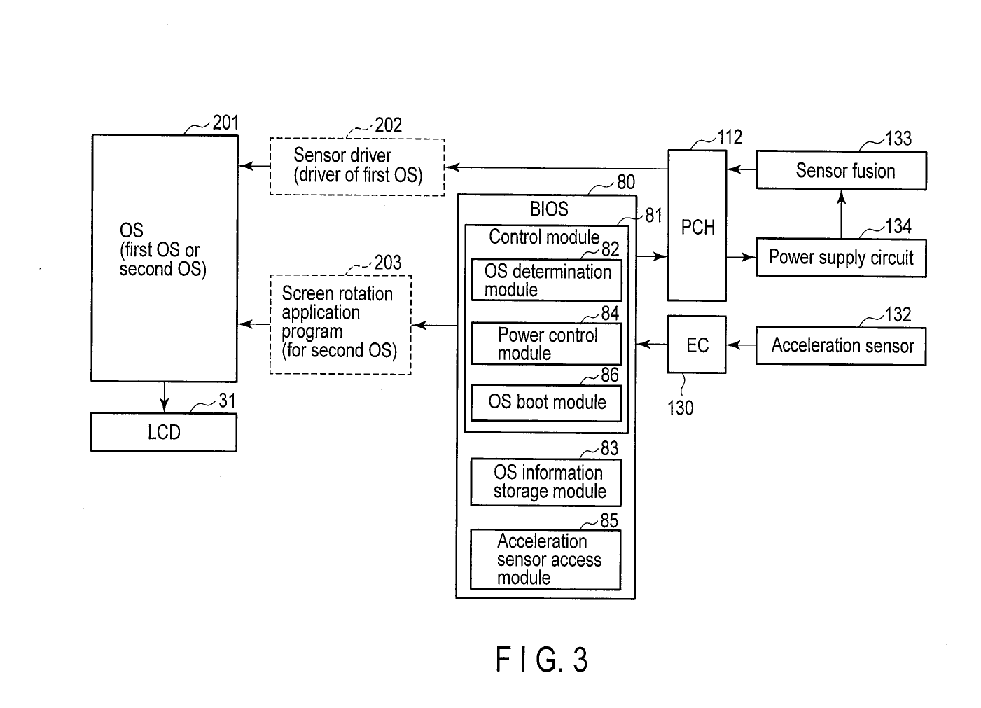

Next, the relationships among a plurality of components provided in the computer 10 will be described with reference to FIG. 3.

The computer 10 comprises an LCD 31, a BIOS 80, the PCH 112, the EC 130, the acceleration sensor 132, the sensor fusion 133, the power supply circuit 134, the OS 201 (the first OS or the second OS), the sensor driver 202 (a driver of the first OS) and the screen rotation application program 203 (an application for the second OS), etc.

The BIOS 80 comprises a control module 81, an OS information storage module 83 and an acceleration sensor access module 85, etc.

The BIOS 80 has a function of, prior to the boot of the OS installed on the computer 10, determining the type of the installed OS (the first OS or the second OS) and automatically controlling the power of the sensor fusion 133 based on the determination result.

The control module 81 comprises an OS determination module 82, a power control module 84 and an OS boot module 86.

Prior to the boot of the installed OS, the OS determination module 82 determines whether the installed OS is the first OS or the second OS. Specifically, the OS determination module 82 may determine whether the installed OS is the first OS or the second OS based on information for identifying the OS booted last time. The information (hereinafter referred to as OS information) for identifying the OS booted last time is stored in a predetermined region (hereinafter referred to as an OS information storage region) within the BIOS-ROM 116. The OS information is, for example, stored in the BIOS-ROM 116 when the OS is shut down. The OS information is, for example, the type or the version information of the OS.

The power control module 84 transmits a control signal for instructing power-on or power-off of the sensor fusion 133 to the power supply circuit 134 via the PCH 112. Specifically, the power control module 84 instructs the power supply circuit 134 to turn the sensor fusion 133 on or off by controlling the above control signal in accordance with the result determined by the OS determination module 82.

After the installed OS is determined to be the first OS by the OS determination module 82 and the sensor fusion 133 is turned on by the power control module 84, the OS boot module 86 boots the installed OS. On the other hand, if the installed OS is determined to be the second OS by the OS determination module 82, the OS boot module 86 boots the installed OS without turning the sensor fusion 133 on.

The OS information storage module 83 obtains OS information and saves the obtained OS information in the OS information storage region. The OS information storage module 83 obtains OS information, for example, by referring to a registry including OS information, etc. The OS information storage module 83 obtains OS information from a registry, etc., when, for example, the OS is shut down. The acceleration sensor access module 85 functions as an access module (BIOS interface) configured to access the register within the EC 130. The second OS or the screen rotation application program 203 can obtain acceleration information of the acceleration sensor 132 via the BIOS interface.

Next, a case where the installed OS is determined to be the first OS by the OS determination module 82 and the first OS is booted as the OS 201 (hereinafter referred to as the case of booting the first OS) will be described.

The OS 201 obtains acceleration information corresponding to the acceleration detected by the acceleration sensor (first acceleration sensor) of the sensor fusion 133 via the sensor driver 202. The OS 201 executes the aforementioned screen rotation function in accordance with the obtained acceleration information. The OS 201 executes the screen rotation function, controls the orientation of a screen image in accordance with the orientation of the computer 10, and displays the screen image on the LDC 31 with the controlled orientation of the screen image.

Next, a case where the installed OS is determined to be the second OS by the OS determination module 82 and the second OS is booted as the OS 201 (hereinafter referred to as the case of booting the second OS) will be described.

The OS 201 obtains acceleration information corresponding to the acceleration detected by the acceleration sensor 132 from the acceleration sensor 132 via the BIOS 80 (BIOS interface) in conjunction with the screen rotation application program 203. Specifically, the acceleration sensor 132 is connected to the EC 130, and the EC 130 comprises a register which is capable of storing the acceleration information corresponding to the acceleration detected by the acceleration sensor 132. The register within the EC 130 can be read by the screen rotation application program 203. The screen rotation application program 203 obtains the acceleration information corresponding to the acceleration stored in the register within the EC 130 via the BIOS interface. The screen rotation application program 203 determines the orientation of the screen image to be displayed on the LCD 31 based on the obtained acceleration information. The screen rotation application program 203 notifies the OS 201 of the determined result. For example, the screen rotation application program 203 notifies the OS 201 of displaying the screen image on the LCD 31 in a vertically or horizontally long manner.

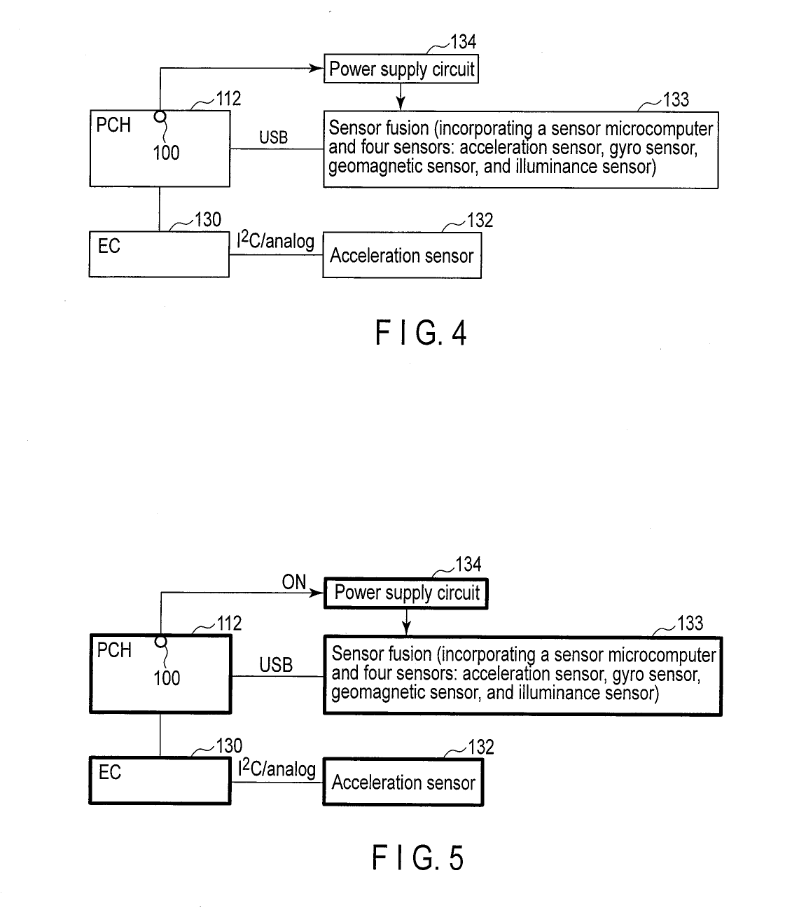

Next, the relationships of each of the sensor fusion 133 and the acceleration sensor 132 with other components will be described with reference to FIG. 4.

The sensor fusion 133 is connected to the PCH 112 via a Universal Serial Bus (USB). The acceleration sensor 132 is connected to the EC 130 via a serial bus different from a USB, such as an I²C bus.

The BIOS 80 can send a control signal to the power supply circuit 134 via a general-purpose input/output port (GPIO) 100 provided in the PCH 112. The power supply circuit 134 turns the sensor fusion 133 on or off in accordance with the control signal from the GPIO 100.

Next, the relationships among components to which power is supplied in the case of booting the first OS will be described with reference to FIG. 5.

In the case of booting the first OS, power is supplied to all of the components shown with thick frames in FIG. 5. All of the components are the PCH 112, the EC 130, the acceleration sensor 132 and the sensor fusion 133.

A process until the sensor fusion 133 is turned on is now explained. First, power (electrical power) is supplied to each of the components excluding the sensor fusion 133. After that, the OS determination module 82 within the BIOS 80 determines that the installed OS is the first OS. Then, a control signal of an active state for turning the sensor fusion 133 on is transmitted to the power supply circuit 134 via the GPIO 100 at an arbitrary timing before the first OS is booted. As a result, power (electrical power) is supplied from the power supply circuit 134 to the sensor fusion 133.

In the case of booting the first OS, power may not be supplied to the acceleration sensor 132. In other words, the acceleration sensor 132 may be turned off. In this case, for example, a second power circuit which turns the acceleration sensor 132 on or off is connected to the acceleration sensor 132. A control signal for turning the second power circuit on or off is input from an external such as the BIOS 80 to the second power circuit. Based on the control signal, the second acceleration sensor 132 may be turned on or off.

The power consumption of the sensor fusion 133 is approximately 1000 times larger than the power consumption of the acceleration sensor 132. Therefore, in the case of booting the first OS, the entire power consumption of the computer 10 is not dramatically increased even if the acceleration sensor 132 is turned on. Specifically, if the power consumption of the sensor fusion 133 is 30 milliwatt, the power consumption of the acceleration sensor 132 is 10 microwatt.

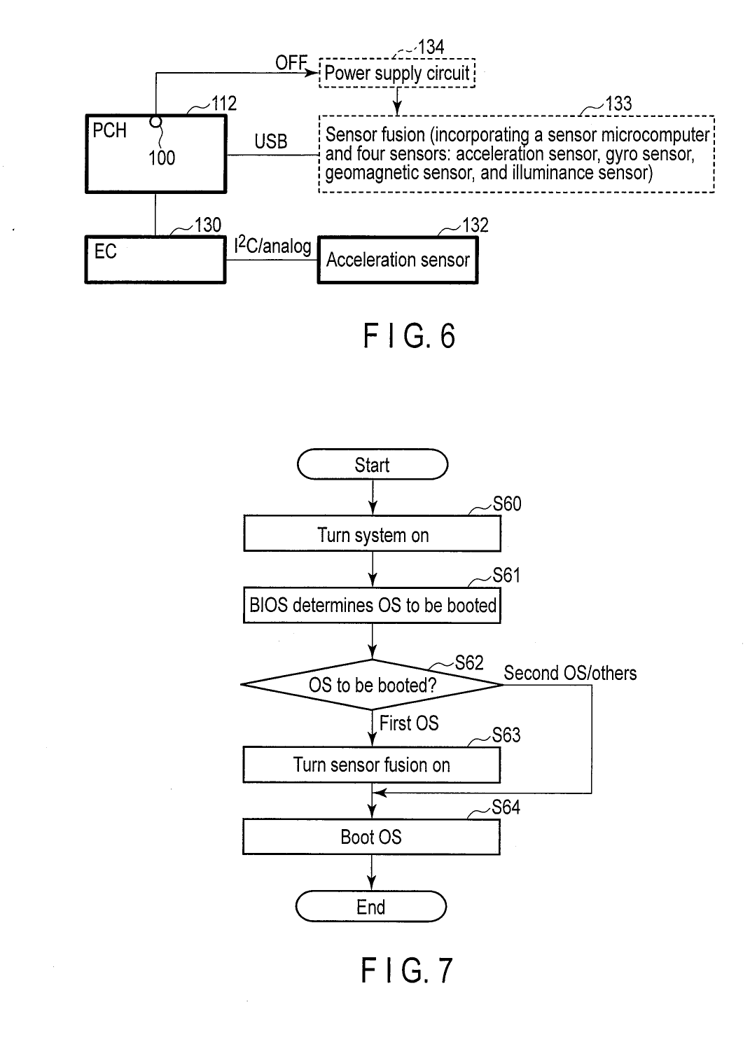

Next, the components to which electrical power is supplied in the case of booting the second OS will be described with reference to FIG. 6.

In the case of booting the second OS, power (electrical power) is supplied to the components shown with thick frames in FIG. 6. The components to which electrical power is supplied are the PCH 112, the EC 130 and the acceleration sensor 132. In the case of booting the second OS, the above-mentioned control signal is maintained at an inactive state. Therefore, the second OS is booted at a state where the sensor fusion 133 is turned off.

Thus, in the case of booting the second OS, the sensor fusion 133 is turned off so as not to operate the sensor fusion 133 which consumes large power. In this manner, it is possible to reduce unnecessary power consumption in the case of booting the second OS.

Next, the procedures for a control process executed by the BIOS 80 will be described with reference to FIG. 7.

The process indicated in FIG. 7 is initiated in response to an operation for booting the computer 10. For example, a user holds down the power switch 16 of the computer 10. By this operation, the computer 10 is turned on (step S60). Then the BIOS 80 determines whether the OS to be booted is the first OS or the second OS based on the above OS information (step S61). If the OS to be booted is determined to be the first OS, the BIOS 80 turns the sensor fusion 133 on (step S63). After that, the BIOS 80 boots the first OS (step S64). If the OS to be booted is determined to be the second OS, or an OS which is not the first OS or the second OS, the BIOS 80 boots the second OS (or the OS which is not the first OS or the second OS) without turning the sensor fusion 133 on (step S64).

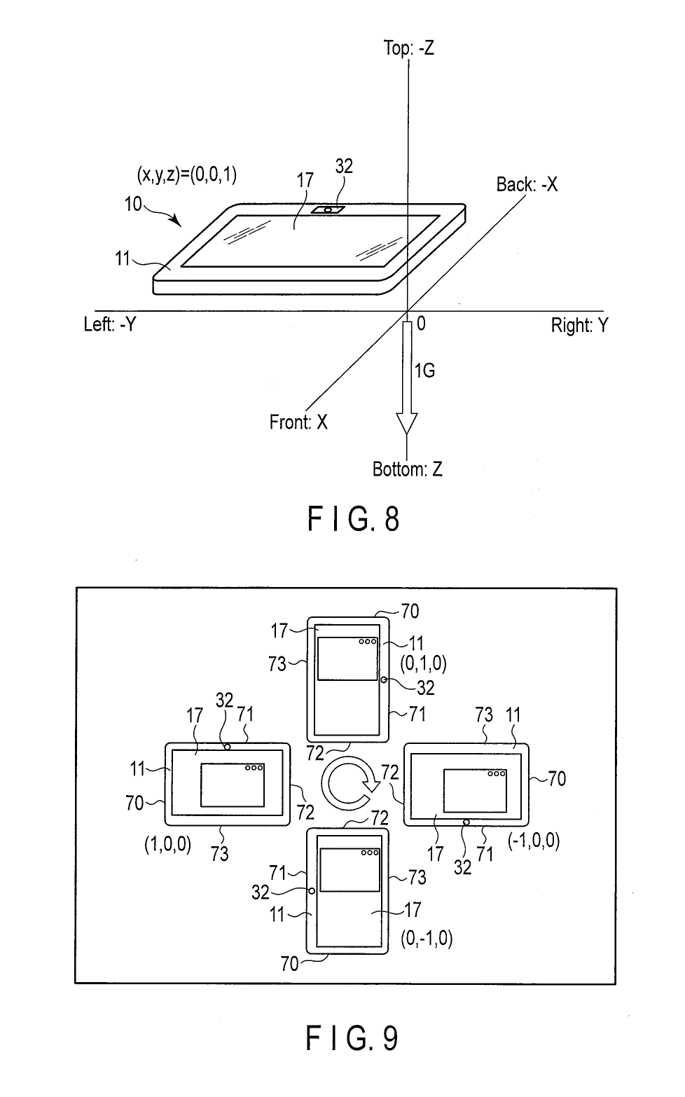

Next, a parameter relating to the acceleration sensor provided in the computer 10 will be described with reference to FIG. 8.

FIG. 8 shows an example of the orientations of each of the three axes of the acceleration sensor 132 or the first acceleration sensor. The X-axis is parallel to a side surface of the computer main body 11 of the computer 10 (or parallel to a side surface of the touchscreen display 17). The front side is set as +X, and the back side is set as −X. The Y-axis is parallel to the front surface of the computer main body 11 (or parallel to the lower end of the touchscreen display 17). The left side is set as −Y, and the right side is set as +Y. The Z-axis is orthogonal to the upper face of the computer main body 11 (or orthogonal to the displaying face of the touchscreen display 17). The upper end side is set as −Z, and the bottom end side is set as +Z.

When the computer 10 is placed on a horizontal plane as indicated in FIG. 8, output (x, y, z) of the acceleration sensor 132 or the first acceleration sensor is (0, 0, 1).

The parameter which relates to the acceleration sensor and is explained with reference to FIG. 8 is merely an example. The allocation of each of the X-, Y- and Z-axes for the computer 10 is not limited to FIG. 8. For example, the X-axis may be an axis orthogonal to the top surface of the computer main body 11.

The screen rotation process executed by the computer 10 will be described with reference to FIG. 9.

For example, orientations of the computer 10 are roughly divided into four types which are landscape orientation (longitudinal orientation), inverted landscape orientation (inverted longitudinal orientation), portrait orientation (horizontal orientation), and inverted portrait orientation (inverted horizontal orientation).

The left part of FIG. 9 shows landscape orientation. When the orientation of the computer 10 is landscape orientation, a display mode is changed to a landscape mode. In the landscape mode, the orientation of a screen image is controlled in such a way that the upper end side of the screen image can be located on an upper line 71 side of the touchscreen display 17, and the lower end side of the screen image can be located on a lower line 73 side of the touchscreen display 17.

The upper part of FIG. 9 shows inverted portrait orientation. When the orientation of the computer 10 is inverted portrait orientation, the display mode is changed to an inverted portrait mode. In the inverted portrait mode, the orientation of a screen image is controlled in such a way that the upper end side of the screen image can be positioned on a left line 70 side of the touchscreen display 17, and the lower end side of the screen image can be positioned on a right line 72 side of the touchscreen display 17.

The right part of FIG. 9 illustrates inverted landscape orientation. When the orientation of the computer 10 is inverted landscape orientation, the display mode is changed to an inverted landscape mode. In the inverted landscape mode, the orientation of a screen image is controlled in such a way that the upper end side of the screen image can be located on the lower line 73 side of the touchscreen display 17, and the lower end side of the screen image can be located on the upper line 71 side of the touchscreen display 17.

The lower part of FIG. 9 indicates portrait orientation. When the orientation of the computer 10 is portrait orientation, the display mode is changed to a portrait mode. In the portrait mode, the orientation of a screen image is controlled in such a way that the upper end side of the screen image can be located on the right line 72 side of the touchscreen display 17, and the lower end side of the screen image can be located on the left line 70 side of the touchscreen display 17.

The screen rotation process explained with reference to FIG. 9 is merely an example. The display mode is not limited to the four types. For example, the number of types of the display mode may be two, five, or more. Further, the orientation of the screen image may be controlled based on the angle of rotation of the screen.

As described above, according to the embodiments, whether the installed operating system is the first OS which can execute control in accordance with the detected values of various types of sensors provided in the sensor fusion 133 or the second OS which can execute control in accordance with the acceleration information is determined prior to the boot of the operating system installed on the computer 10. If the installed operating system is determined to be the first OS, the installed operating system can be booted after the sensor fusion 133 is turned on. If the installed operating system is determined to be the second OS, the installed operating system can be booted without turning the sensor fusion 133 on. Specifically, in the computer 10 which supports both of the first OS and the second OS, it is possible to support an automated control function of the orientation of a screen image in accordance with the orientation of the computer 10. Moreover, even when an operating system which does not support the sensor fusion 133 is booted, the power consumption of a system can be optimized (reduced). The optimization of the power consumption is conducted without a conscious operation by a user. Specifically, when an operating system which does not support the sensor fusion 133 is booted, a screen rotation function equivalent to the case of booting an operating system which supports the sensor fusion 133 can be executed with the optimized power consumption without operating the sensor fusion 133 consuming comparatively large power by using the acceleration sensor 132 which is connected to the EC 130 and consumes small power. The computer 10 comprises the acceleration sensor access module 85. By this configuration, the computer 10 can access the above-described register within the EC 130 without using the sensor driver 202. Moreover, as the computer 10 comprises the power supply circuit 134 which can turn the sensor fusion 133 on or off depending on the control signal input from an external, the computer 10 is capable of separately controlling power-on and power-off of the sensor fusion 133.

As explained with reference to FIG. 6, in the case of booting the second OS, the second OS is booted at a state where the sensor fusion 133 is turned off. However, the second OS may be also booted as follows. For example, a user holds down the power switch 16 of the computer 10. By this operation, the computer 10 is turned on. Then, the sensor fusion 133 is turned on until the OS to be booted is determined to be the second OS. After that, if the OS to be booted is determined to be the second OS, the second OS may be booted with the sensor fusion 133 turned off.

Moreover, the acceleration sensor access module 85 may not be the BIOS interface. For example, the acceleration sensor access module 85 may be firmware which can access the register within the EC 130.

In the embodiments, the acceleration sensor is explained. However, the same explanation as above is applied to the illuminance sensor, etc. provided in the sensor fusion 133 other than the acceleration sensor.

Each function of the components shown in FIG. 3 can be realized by software (computer program). Therefore, the same effect as the embodiments described herein can be easily realized by installing the software on a normal computer through a computer-readable storage medium in which the software is stored, and executing the software.

The screen rotation application program 203 explained in the embodiments may be realized by a dedicated LSI, a DSP, or hardware such as a microcomputer.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a sensor module comprising a plurality types of sensors including a first acceleration sensor;
a second acceleration sensor; and
a controller configured to, before booting an operating system installed on the electronic apparatus, determine whether the installed operating system is a first operating system allowed to execute control in accordance with detected values of the plurality types of sensors or a second operating system allowed to execute control in accordance with acceleration information, the controller being further configured to boot the installed operating system after the sensor module is turned on if the installed operating system is determined to be the first operating system, and to boot the installed operating system without turning the sensor module on if the installed operating system is determined to be the second operating system.

2. The electronic apparatus of claim 1, wherein the first operating system supports the sensor module, and the second operating system does not support the sensor module.

3. The electronic apparatus of claim 1, wherein
the second acceleration sensor is connected to an embedded controller configured to manage power of the electronic apparatus, and
the embedded controller comprises a register which is capable of storing and reading acceleration information corresponding to acceleration detected by the second acceleration sensor.

4. The electronic apparatus of claim 3, further comprising an access module configured to access the register within the embedded controller, wherein
the second operating system obtains the acceleration information corresponding to the acceleration detected by the second acceleration sensor via the access module.

5. The electronic apparatus of claim 1, wherein the controller is configured to determine whether the installed operating system is the first operating system or the second operating system based on information for identifying an operating system last time.

6. The electronic apparatus of claim 1, further comprising a power supply circuit configured to turn the sensor module on or off in accordance with a control signal input from an external, wherein
the controller is configured to instruct the power supply circuit to turn the sensor module on or off by controlling the control signal.

7. The electronic apparatus of claim 1, wherein the sensor module comprises the first acceleration sensor, a gyro sensor, a geomagnetic sensor and an illuminance sensor.

8. The electronic apparatus of claim 1, wherein the sensor module is connected to a system controller within the electronic apparatus via a universal serial bus, and the second acceleration sensor is connected to an embedded controller within the electronic apparatus via a serial bus different from the universal serial bus.

9. A control method of an electronic apparatus comprising a sensor module and a second acceleration sensor, the sensor module comprising a plurality types of sensors including a first acceleration sensor, the method comprising:
determining, before booting an operating system installed on the electronic apparatus, whether the operating system installed on the electronic apparatus is a first operating system allowed to execute control in accordance with detected values of the plurality types of sensors or a second operating system allowed to execute control in accordance with acceleration information;
booting the installed operating system after turning the sensor module on if the installed operating system is determined to be the first operating system; and
booting the installed operating system without turning the sensor module on if the installed operating system is determined to be the second operating system.

10. A computer-readable, non-transitory storage medium having stored thereon a computer program which is executable by a computer, the computer comprising a sensor module and a second acceleration sensor, the sensor module comprising a plurality types of sensors including a first acceleration sensor, the computer program controlling the computer to execute functions of:
determining, before booting an operating system installed on the computer, whether the installed operating system is a first operating system allowed to execute control in accordance with detected values of the plurality types of sensors or a second operating system allowed to execute control in accordance with acceleration information;
booting the installed operating system after turning the sensor module on if the installed operating system is determined to be the first operating system; and
booting the installed operating system without turning the sensor module on if the installed operating system is determined to be the second operating system.
